(19) United States
(12) Patent Application Publication
(10) Pub. No.: US 2018/0336642 A1
(43) Pub. Date: Nov. 22, 2018

(54) Normalizing Allowable Budget of Travelers

(71) Applicant: Amgine Technologies (US), Inc., Austin, TX (US)

(72) Inventor: Harold Roy Miller, Toronto (CA)

(21) Appl. No.: 15/979,275

(22) Filed: May 14, 2018

Related U.S. Application Data
(60) Provisional application No. 62/507,643, filed on May 17, 2017.

(51) Int. Cl. G06Q 40/00; G06Q 10/02

(52) U.S. Cl. CPC G06Q 40/12; G06Q 10/025

(57) ABSTRACT

This disclosure is generally directed to a method and system for business travel and expense management. An example method comprises receiving a travel-related query from a user associated with a business entity. The travel-related query is parsed to derive at least one attribute, such as travel arrangement details or preferences. Furthermore, a normalized allowable budget for the user is determined based at least in part on the at least one attribute related to the travel-related query. The normalized allowable budget is dynamically determined by applying business entity rules or artificial intelligence against historical travel data associated with one or more users. Furthermore, feasible travel itineraries for the user are selected based on the normalized allowable budget and the travel-related query and presented to the user via a user interface.

### CROSS-REFERENCE TO RELATED APPLICATIONS

This application claims the benefit of U.S. Provisional Patent Application Ser. No. 62/507,643 filed May 17, 2017 and entitled “Normalizing Allowable Budget of Travelers,” which is incorporated herein by reference in its entirety for all purposes.

### BACKGROUND

### Technical Field

The present disclosure relates to travel planning and management systems and, more particularly, to methods and systems for facilitating business travel planning and management.

### Description of Related Art

Business travel can often be fraught with unpredictable prices and inconvenient schedules. Employees prefer convenient schedules and travel options, while their employers are concerned with the travel costs. Successfully balancing the two conflicting interests can be a challenging task with traditional business travel planning systems. Furthermore, researchers suggest that approximately 50% of all business travelers change their itineraries at least once, which can lead to additional and, often high, unexpected costs. As a result, many employees avoid using company travel planning systems altogether and prefer publicly available online travel services.

The approaches described in this section could be pursued but are not necessarily approaches that have been previously conceived or pursued. Therefore, unless otherwise indicated herein, the approaches described in this section are not prior art to the claims in this document and are not admitted to be prior art by inclusion in this section.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

This disclosure is generally directed to aspects of business travel management and planning, and, specifically, to a method and system for business travel and expense managing. An example method comprises receiving a travel-related query from a user. The travel-related query includes an identifier of the user, where the user is related to a business entity. The “business entity” may refer to a for-profit organization, non-for-profit organization, governmental agency, partnership, association, and the like. The “user” can be also referred to as a traveler or business traveler, and also an employee, contractor, officer, or agent of the business entity.

The method can further comprise parsing the travel-related query to derive at least one attribute related to the travel-related query. The attribute may relate to travel dates and times, destinations and departure locations, travel selections or preferences, hotel accommodation parameters, and any other travel arrangement details. The method can further comprise determining a normalized allowable budget for the user based at least in part on the at least one attribute related to the travel-related query and selecting one or more feasible travel itineraries for the user based on the normalized allowable budget and the travel-related query. The normalized allowable budget can be dynamically determined by applying predetermined business entity rules or artificial intelligence, including, for example, machine-learning, against historical travel data associated with one or more users. The method further comprises presenting the one or more feasible travel itineraries to the user. As such, the feasible travel itineraries are all within the normalized allowable budget to make sure that the user travel preferences are satisfied to the extent possible, while travel costs for the business entity remain within a predefined range.

An example travel management system comprises a user interface configured to receive a travel-related query from a user related to a business entity, where the travel-related query includes an identifier of the user and a processing module. The processing module can be configured to parse the travel-related query to derive at least one attribute related to the travel-related query, determine a normalized allowable budget for the user based at least in part on the at least one attribute related to the travel-related query, and select one or more feasible travel itineraries for the user based on the normalized allowable budget and the travel-related query. The user interface can be further configured to present the one or more feasible travel itineraries to the user.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example and not limitation in the figures of the accompanying drawings, in which like references indicate similar elements.

FIG. 1 illustrates a computer architecture within which embodiments of the present disclosure can be implemented.

FIG. 2 illustrates a process flow diagram showing a method for business travel and expense management according to an example embodiment.

FIG. 3 illustrates a computer system that can be used to implement the method for business travel and expense management.

### DETAILED DESCRIPTION OF EXAMPLE EMBODIMENTS

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

This disclosure generally concerns the technology for facilitating business travel management and planning, and, more specifically, a method and system for business travel and expense management. Embodiments of the present disclosure allow facilitating business travel through a fully automated end-to-end system that enables a traveler to make changes to an itinerary in real-time, while avoiding increases in travel costs for the employer. Although this disclosure focuses on planning and managing business travel, the embodiments of this disclosure can be applicable to planning and managing personal (non-business) travel without departing from the concepts disclosed herein.

The system provides advantages that are impossible to realize by a traditional human-based travel agent model. For example, a human travel agent has limited capacity and is thus only capable of providing travel services to a limited number of people. Furthermore, travel agent services provided by a human agent are inconsistent and can vary from one agent to another. In addition, change management and data curation cannot be performed by a typical travel agent.

Using the system of this disclosure allows a business to experience significant cost savings and scalability. Furthermore, changes to an itinerary in real-time can be made more efficiently as all available travel options can be searched, filtered, and presented to a user in an efficient, organized, and curated manner. In addition, the system disclosed herein allows for travel schedules and itineraries to be controlled completely by the traveler while still allowing the traveler to take advantage of access to market specials available only to businesses. Notably, if a business has rules, policies, preferred budgets, preferred vendors, and so forth (collectively referred to as “travel guidelines”), the system presents these to the user (traveler) and automatically applies them in order to comply with the corporate travel guidelines for each individual business.

Moreover, the system of this disclosure can be embodied as two sub-systems with linear interfaces between the sub-systems. The first sub-system can be used by users and provide complete control over logistics and management of travel. The second sub-system can be used by a business to sanction travel and ensure compliance with its travel guidelines, such as by restricting amounts users can claim for reimbursement of their travel expenses.

In various embodiments, a user interface is used by the system to provide travelers with the ability to make, manage, and update travel arrangements over the Internet in substantially real-time. In this way, each traveler is fully in control of when and how travel plans are made and has the ability to update the travel plans as necessary at any time, including mid-initerary.

The system can be also configured to determine or calculate a “normalized” allowable budget for each individual traveler based on a traveler's individual profile and by using artificial intelligence (AI) algorithms. More information on traveler profiles can be found in co-pending U.S. patent application Ser. No. 14/676,302 filed on Apr. 1, 2015 entitled “Inference Model for Traveler Classification”, the disclosure of which is hereby incorporated by reference in its entirety.

The normalized allowable budget can be determined by processing historical travel data using AI (e.g., a machine-learning system or algorithm) and predetermined travel rules (guidelines) specific to a business or a traveler. The system can determine the normalized allowable budget of travel for various classifications of travelers and trips at various times. For example, a corporation can determine that $600 for a flight from Los Angeles to New York City is an average price for economy class airfare, and thus the company can apply its travel guideline to reimburse the employee for up to that amount for the flight. An employee may choose a flight that is more expensive knowing that only $600 will be reimbursed by the company and the rest of the cost is the employee's responsibility.

However, for executive-level travel, the company travel guidelines can provide higher cost limits to cover business class airfare. Thus, for an executive to fly from Los Angeles to New York City, $3,000 may be an average price for a business class airfare. Thus, the company will reimburse an executive up to that amount for the flight. In this way, the company may have travel guidelines that provide a different amount of travel allowance for different classifications of employees traveling the same route. Traveler profiles may include data for the normalized allowable budget for a specific traveler.

The normalized allowable budget for travel may further be dynamically adjusted based on other factors affecting cost, such as a time of day of travel, day of week, or special events. For example, while an economy airplane ticket from Los Angeles to New York City may typically cost an average of $600, the cost may be higher during a specific even in New York City, such as the annual New Year's Celebration or Thanksgiving Day Parade. Through the data accumulated for the past travel costs, a second subsystem may determine that travel on December 31^{st} is historically 25% more expensive. Thus, the system may adjust the normalized allowable budget for travel on that date by a comparable amount. In this way, the normalized allowable budget can be dynamically varied based on a traveler profile, geographic location, time of day, day of the week, special event, or any other factor or combination of factors affecting the cost.

The amount of normalized allowable budget for a traveler may be determined by the system based on historical data for the particular traveler, all travelers of a particular traveler classification within a company, all travelers of a company, or travelers associated with multiple companies. In some embodiments, the historical data is gathered and analyzed through the use of electronic payment means, such as through a credit card processor, wire transfer processor, expense report processor, and the like.

The normalized allowable budget of travel may be also determined based on data analytics, such as determining an average, median, mean, or other values for a particular travel component. The normalized allowable budget of travel may further be adjusted based on a company policy (guidelines), such as business limits on reimbursing a certain percentage of average cost. For example, a company may decide that they will reimburse for up to 80% of flight costs on a day when airplane tickets are historically lower (such as Tuesdays and Sundays), and will reimburse 60% on days when airplane tickets are historically higher (such as Fridays and Saturdays). As would be understood by persons of ordinary skill in the art, the amount of reimbursement can be variable by time of day, day of week, calendar day, special event, geographic location, company providing a travel service, traveler profile and/or classification, or any other factor(s) affecting cost.

By determining a normalized allowable budget for a business traveler, the company can keep its costs within predictable ranges. Further, this allows the traveler to know in advance how much of travel costs will be reimbursed so the traveler can willingly choose to select more expensive itineraries and items at their own personal cost.

Additionally, by analyzing the historical data (i.e., all travel-related data up to the present time), a business can see where money has historically been spent by people in a particular area and provide recommendations accordingly. For example, a person in a new city may need a recommendation for a restaurant. While an internet search may yield a highly rated restaurant, there may actually be a smaller establishment that provides food comparably high quality. Thus, by tracing where people have spent money in the past or are currently spending money, recommendations within a normalized allowable budget may be generated by the system and presented to a user via a user interface. Further, the recommendations can be adjusted and filtered based on unique characteristics of a person from their traveler profile (such as, for example, cuisine preferences or dietary restrictions).

If a corporation has a preferred supplier discount, for example, Hilton hotels, the system can calculate or specify the rate for any/all Hilton hotels in the solution space and factor this into the normalized price. If the Hilton hotels are priced above the normalized price, then only a firm corporate rule would allow them to be selected within the normalized price. If they are priced below the normalized price, then again only a rule would force their selection.

Accordingly, the system and the method thereof provide considerable advantages over traditional approaches for travel planning and management. Both the business and the traveler can be assured they are selecting travel options within a meaningful norm. The traveler knows that the business will be fair in reimbursing for travel and the business can be assured does not pay more than the going rate for travel. In addition, the business can manage costs of travel expenses while still providing the traveler with options and choice regarding travel arrangements.

Further, in some embodiments, the system may filter the travel options displayed to a user according to the normalized allowable budget that will be reimbursed by the business. For example, the user interface may only display hotel choices that are within the normalized allowable budget for the specific traveler, or they may display those within the normalized budget at the top of the screen. Additionally, the business can adjust the normalized allowable budget at any time, for any reason, and for any class or subgroup of employees, to adjust its travel budget. For example, travel options from only certain companies may be displayed to a user based on the normalized allowable budget.

In some embodiments, the normalized allowable budget is determined by the system for each component of a travel itinerary (e.g., flight, hotel, rental car, or entertainment). In other embodiments, a normalized travel budget is determined by the system for a complete travel itinerary for a traveler (i.e., all components together). In this way, the traveler can choose a more expensive flight with a cheaper rental car, or any other combinations thereof.

In still other embodiments, the normalized allowable budget can be determined for a group of people traveling together, such as a group of employees traveling to a conference. A normalized travel budget may also be determined for any group of people, such as all employees within a department, all departments within a business location, all employees within a certain classification (i.e. C-suite executives), or any combination thereof. In these embodiments, the system may maintain a running tally of all funds expended thus far on travel and adjust the normalized allowable budget for future travel within the fiscal period accordingly.

The embodiments of this disclosure will now be presented with reference to a computer-implemented system and methods for business travel and expense managing. These system and method are described and illustrated in the accompanying drawings by various blocks, components, circuits, steps, operations, processes, algorithms, and the like, collectively referred to as “elements.” These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “computing system” that includes one or more processors. Examples of processors include microprocessors, microcontrollers, Central Processing Units (CPUs), digital signal processors (DSPs), field programmable gate arrays (FPGAs), programmable logic devices (PLDs), state machines, gated logic, discrete hardware circuits, and other suitable hardware configured to perform various functions described throughout this disclosure. One or more processors in the processing system may execute software, firmware, or middleware (collectively referred to as “software”). The term “software” shall be construed broadly to mean instructions, instruction sets, code, code segments, program code, programs, subprograms, software components, applications, software applications, software packages, routines, subroutines, data objects, executables, threads of execution, procedures, functions, etc., whether referred to as software, firmware, middleware, microcode, hardware description language, or otherwise.

Therefore, in one or more embodiments of this disclosure, the functions described may be implemented in hardware, software, or any combination thereof. If implemented in software, the functions may be stored on or encoded as one or more instructions or code on a non-transitory computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage, solid state memory, or any other data storage devices, combinations of the aforementioned types of computer-readable media, or any other medium that can be used to store computer executable code in the form of instructions or data structures that can be accessed by a computer.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Additionally, the term “user device” refers to a personal computer, a laptop computer, tablet computer, desktop computer, smartphone, mobile phone, Internet phone, netbook, set top box, smart television device, multimedia player, personal digital assistant, server computer, network storage computer, game console, entertainment system, infotainment system, in-vehicle computer, navigation system, or any other computing system comprising at least a processor, input, output, and network capabilities.

The term “business” or “business entity” refers to an organization, including without limitation, a for-profit organization (e.g., a public or private corporation or limited liability company), non-for-profit organization (e.g., a church, association), trust, governmental agency, partnership, or any other entity. The term “user” should mean a person associated with a business, such as an employee, partner, or owner of the business. The terms “user,” “traveler,” and “employee” can be used interchangeably.

The term “user interface” refers to a mechanism for data exchange between a user device and a server (e.g., a travel management system). Some examples of user interface include, without limitation, a graphical user interface (GUI), voice-enabled interface with speech recognition and natural language processing, text interface, web service, Application Programming Interface (API), and so forth. The user interface can reside at the server, the user device, or both.

The term “attribute” refers to a parameter, value, name, or variable of a travel. Some examples of attribute include, without limitation, a departure location, an arrival location, travel time, travel date, travel means (e.g., flight, ferry, rental car, etc.), travel preferences, and the like.

The term “normalized allowable budget” refers to an amount of money (real currency or virtual currency) associated with travel, entertainment, lodging, food, and per diem costs. The term “itinerary” refers to a document detailing travel and optionally entertainment arrangements. It can include a schedule of one or more events (e.g., a flight, car rental, entertainment, lunch, dinner, hotel, entertainment, etc.) and information regarding times of events, arrival times for events, duration times of events, and departure times for events. For example, a travel itinerary can include travel booking details, such as a flight number, arrival location, arrival time and date, departure location, departure time and date, hotel accommodation details, car rental details, and so forth.

Referring now to the drawings, exemplary embodiments are described. The drawings are schematic illustrations of idealized example embodiments. Thus, the example embodiments discussed herein should not be construed as limited to the particular illustrations presented herein, rather these example embodiments can include deviations and differ from the illustrations presented herein.

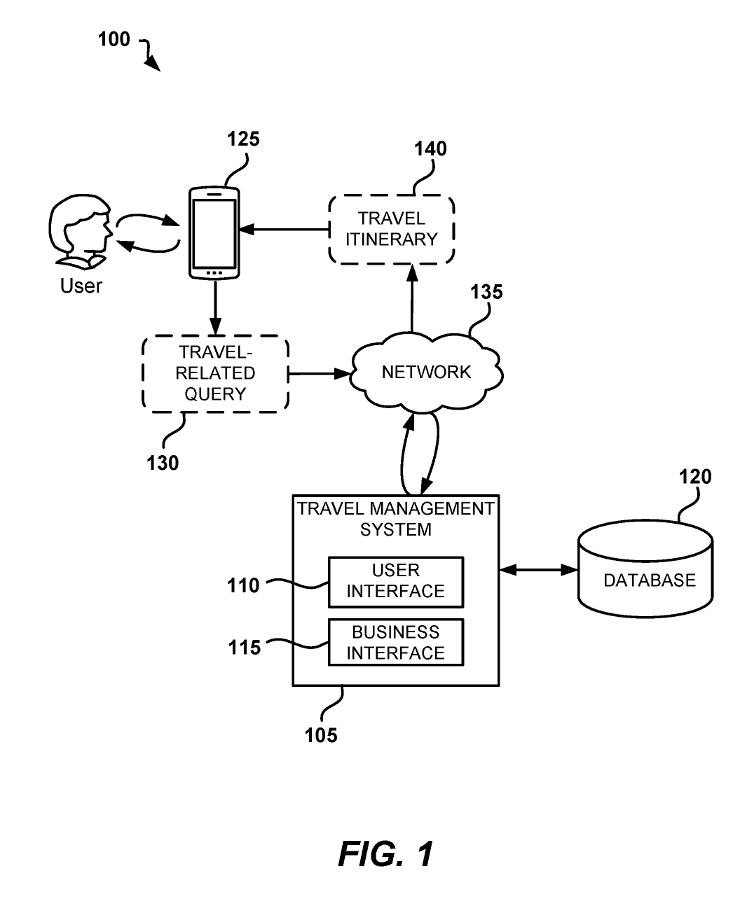

FIG. 1 illustrates a computer architecture 100 within which embodiments of the present disclosure can be implemented. Computer architecture 100 includes a travel management system 105 implemented by one or more computer servers. Generally, travel management system 105 provides optimization-based travel itinerary planning and management to aid travelers directed at constructing value- or utility-maximizing travel itineraries based on multiple factors, business travel guidelines, policies, traveler interests, budget constraints, and travel preferences. More specifically, travel management system 105 brings a portfolio-analytic frame to the travel itinerary choice task. By making the travel planning process more efficient, the likelihood of consumer ex post purchase satisfaction will increase because of enhanced decision quality while also controlling costs for a business.

Travel management system 105 may include two sub-systems: one for users and another for businesses. As such, travel management system 105 includes two interfaces for exchanging data with users (travelers) and businesses. Respectively, travel management system 105 includes a user interface 110 for communicating with the users and a business interface 115 for communicating with the businesses. The users and businesses can use user interface 110 and business interface 115, respectively, to establish and manage their profiles, create inquires, obtain travel itineraries, process expense reports associated with user travel, and so forth. The user and business profiles are stored and maintained in one or more databases 120.

Both users and businesses have their respective profiles established with system 105 in order to create and manage their travel and budget preferences. For example, a user can specify in their profiles airline and hotel preferences, food restrictions, preferred airports, updated personal information, and so forth. A business can specify in its profile budget restrictions, travel rules, travel policies, travel guidelines, airline and hotel preferences, contact details, expense preferences, and so forth.

Travel management system 105 includes at least one processing module (e.g., a computing device) and can operate based on a decision framework that provides a structural basis from which to approach travel itinerary planning and is capable of supporting evaluative challenges entailed in identifying of the itinerary options-combinations that maximize or enhance overall itinerary value for the users. Moreover, travel management system 105 provides a portfolio-analytic decision framework that brings a holistic orientation to how problems of allocative efficiency are approached within the context of the itinerary choice task. A travel itinerary portfolio can be structured hierarchically in terms of one or more itinerary categories or groups. A portfolio group can describe typical itinerary elements such as flights, hotel options, and so forth as well as ground transportation options, tours, and so forth.

Still referring to FIG. 1, system architecture 100 includes one or more user devices 125 operated by users (travelers). User devices 125 can include personal computers, smartphones, and the like. In general, user device 125 can be used to exchange data with travel management system 105, including, for example, creating and managing user profiles, generating travel-related inquires, receiving, presenting, and processing travel itinerates, generate expense reports, and the like. Similar user devices can be used by business representatives to communicate with travel management system 105 and create and manage business profiles, create and manage travel guidelines, rules, policies, budget restrictions, and so forth.

Thus, a user can operate its user device 125 to generate a travel-related query 130 via, for example, a graphical user interface displayed on user device 125. Travel-related query 130 may include text data and a user identifier. The text data may be input via the graphical user interface by the user or obtained as a natural language input by the user, by speech-to-text conversion of an oral exchange with the user, or otherwise. In some embodiments, the user may be asked, using visual displayable or audio prompts, one or more motivating questions in order to receive relevant travel-related query 130. Travel-related query 130 can include a time and date for travel, destination, departure location (e.g., a departure and arrival airport), hotel and travel preferences, personal information (e.g., name, contact information), and so forth.

Travel-related query 130 may be transmitted to travel management system 105 for facilitating optimization-based travel itinerary planning via a communications network 135. Communications network 135 may include the Internet or any other network capable of communicating data between devices. Suitable networks 135 may include or interface with any one or more of, for instance, a local intranet, a Personal Area Network, a Local Area Network, a Wide Area Network, a virtual private network, cellular phone networks, Bluetooth radio, Ethernet network, an IEEE 802.11-based radio frequency network, Internet Protocol (IP) communications network, or any other data communication network utilizing physical layers, link layer capability, or network layer to carry data packets, or any combinations of the above-listed data networks.

User device 125, in some example embodiments, may include a graphical user interface for displaying the user interface associated with travel management system 105. In other embodiments, user interface 110 may reside in user device 125. The user may communicate with travel management system 105 via a client application available through user device 125. In other words, user device 125 may run a software (mobile) application configured to exchange data with travel management system 105 using API, proprietary data communications protocol, web service, and the like. In other embodiments, user device 125 may run a browser enabling the user to visit an interactive website associated with travel management system 105 and user interface 110.

When travel management system 105 receives travel-related query 130, travel management system 105 processes travel-related query 130 as discussed below and generates a travel itinerary 140. Travel management system 105 sends travel itinerary 140 to user device 125 via network 135. When user device 125 receives travel itinerary 140, user device 125 presents travel itinerary 140 to the user in the form of a displayable content, audible content, multimedia content, printable content, file, data object, or in any other suitable format. Travel itineraries, such as travel itinerary 140, can be available for system 105, for example, from one or more databases 120. They may be analyzed based on preference data of the one or more users or businesses.

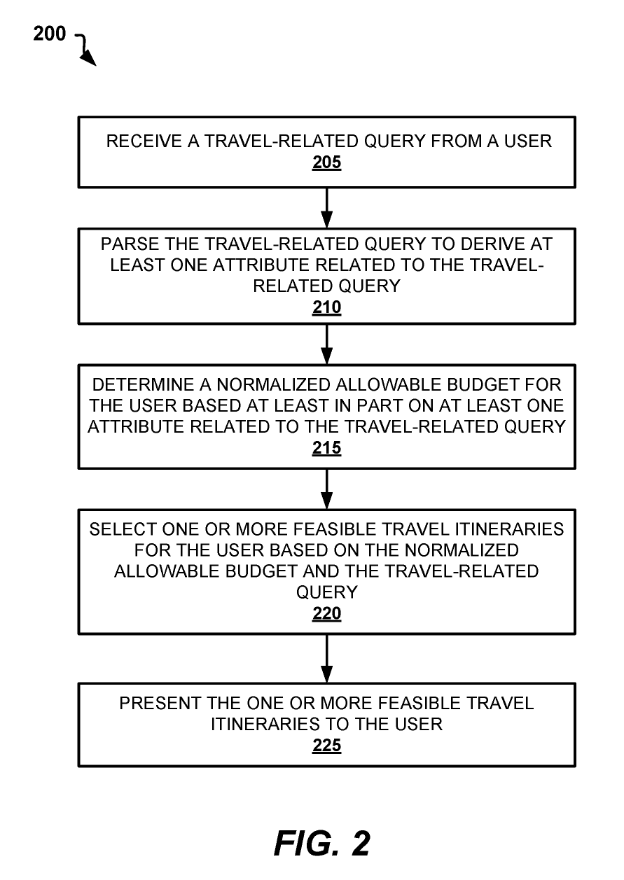

FIG. 2 is a process flow diagram showing a method 200 for business travel and expense managing according to an example embodiment. Method 200 may be performed by processing logic that may comprise hardware (e.g., decision-making logic, dedicated logic, programmable logic, application-specific integrated circuit, and microcode), software (such as software run on a general-purpose computer system or a dedicated machine), or a combination of both. In one example embodiment, the processing logic refers to travel management system 105. Below recited operations of method 200 may be implemented in an order different than described and shown in the figure. Moreover, method 200 may have additional operations not shown herein, but which can be evident for those skilled in the art from the present disclosure. Method 200 may also have fewer operations than outlined below and shown in FIG. 2.

Method 200 may commence at operation 205 with travel management system 105 receiving a travel-related query from a user (e.g., business traveler). The user is associated with a business entity. In other words, the user can be an employee, agent, officer, or contractor of the business entity. The travel-related query can include an identifier of the user and one or more travel arrangement parameters, details, attributes, and the like. For example, the travel-related query can include a travel route, location, dates, destination names, preferences, and so forth. The travel-related query can be generated by the user via user interface 110, which can refer to a web service or graphical user interface.

At operation 210, a processing module of travel management system 105 parses the travel-related query to derive at least one attribute related to the travel-related query. As discussed above, the attribute can include one or more of the following: travel time and date, a departure location, an arrival location, a travel preference, a hotel selection, a location for hotel accommodation, and a hotel accommodation date.

At operation 215, the processing module of travel management system 105 can determine (e.g., calculates) a normalized allowable budget for the user based at least in part on the at least one attribute related to the travel-related query. Travel management system 105 can determine the normalized allowable budget, for example, by applying predetermined rules of the business entity against historical travel data or by running a machine-learning algorithm on the historical travel data. Here, the historic travel data can be associated with one or more of the following: past travel data of the user, past travel data of other users of same classification within the business entity (e.g., past travel data of employees of the same rank), past travel data of other users of the business entity, and past travel data of other users of other business entities. The past travel data can be aggregated by travel management system 105 in database 120.

Notably, each of the feasible travel itineraries and the travel-related query includes a plurality of common components, including at least one of the following: a flight, hotel, rental car, and entertainment. In some embodiments, the normalized allowable budget is determined or dynamically adjusted for each of the common components.

In additional embodiments, the processing module of travel management system 105 can further dynamically adjust the normalized allowable budget based on one or more of the following: a time of day of travel, a day of travel, a special event, a geographic location of the user, a user profile, a business entity profile, and business entity travel guidelines.

At operation 220, the processing module of travel management system 105 selects one or more feasible travel itineraries for the user based on the normalized allowable budget and the travel-related query. The feasible travel itineraries are selected such that a cost of each of the feasible travel itineraries is equal or less than the normalized allowable budget. Also, each of the feasible travel itineraries can be selected based on a user classification within the business entity (e.g., an employee rank, status, or category).

In some embodiments, travel management system 105 selects each of the feasible travel itineraries based on the user profile or the business profile. As discussed above, each user can remotely create and a manage a user profile that is stored by database 120 and each business entity can remotely create and a manage a business profile that is also stored by database 120. The user profile can include user travel preferences, while the business profile including business travel guidelines or business rules at least for the normalized allowable budget. In addition, the business travel guidelines can include variable parameters that cause dynamic adjusting of the normalized allowable budget by time of day, a day of week, a calendar day, a special event, a geographical location of the user, and a service provider name.

At operation 225, user interface 110 or travel management system 105 presents the feasible travel itineraries to the user. In some embodiments, the feasible travel itineraries can be filtered by travel management system 105 according to the normalized allowable budget.

Further operations of method 200 may include receiving a selection from user interface 110 for one of the feasible travel itineraries. Accordingly, travel management system 105 can perform automatic booking arrangements associated with the selected feasible travel itinerary and automatically report the booking arrangements to the user and the business entity. In addition, travel management system 105 can automatically generate an expense report based on the booking arrangements and present the expense report to the business entity.

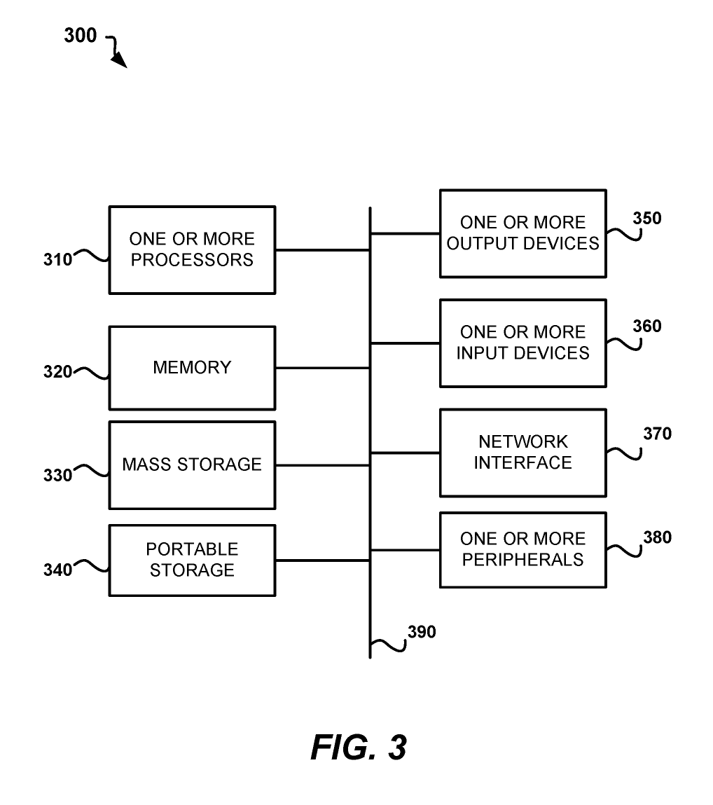

FIG. 3 is a block diagram illustrating an example computer system 300 suitable for implementing the methods described herein. In particular, computer system 300 may be an instance of system 105 or user device 125, or any parts thereof. FIG. 3 illustrates just one example of computer system 300 and in other embodiments computer system 300 may have fewer elements than shown in FIG. 3 or more elements than shown in FIG. 3.

Computer system 300 includes one or more processors 310, a memory 320, one or more storage devices 330, a portable storage 340, one or more input devices 350, one or more output devices 360, network interface 370, and one or more peripherals 380. These elements can be operatively interconnected via a communication bus 390. Processors 310 are, in some examples, configured to implement functionality and/or process instructions for execution within computer system 300. For example, processors 310 may process instructions stored in memory 320 or instructions stored on storage devices 330. Such instructions may include components of an operating system or software applications.

Memory 320, according to one example, is configured to store information within computer system 300 during operation. Memory 320, in some example embodiments, may refer to a non-transitory computer-readable storage medium or a computer-readable storage device. In some examples, memory 320 is a temporary memory, meaning that a primary purpose of memory 320 may not be long-term storage. Memory 320 may also refer to a volatile memory, meaning that memory 320 does not maintain stored contents when memory 320 is not receiving power. Examples of volatile memories include RAM, dynamic random-access memories (DRAM), static random-access memories (SRAM), and other forms of volatile memories known in the art. In some examples, memory 320 is used to store program instructions for execution by processors 310. Memory 320, in one example, is used by software. Generally, software refers to software applications suitable for implementing at least some operations of the methods as described herein.

Storage devices 330 can also include one or more transitory or non-transitory computer-readable storage media and/or computer-readable storage devices. In some embodiments, storage devices 330 may be configured to store greater amounts of information than memory 320. Storage devices 330 may further be configured for long-term storage of information. In some examples, the storage devices 330 include non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

Still referencing to FIG. 3, computer system 300 may also include one or more input devices 350. Input devices 350 may be configured to receive input from a user through tactile, audio, video, or biometric channels. Examples of input devices 350 may include a keyboard, keypad, mouse, trackball, touchscreen, touchpad, microphone, one or more video cameras, image sensors, fingerprint sensors, or any other device capable of detecting an input from a user or other source and relaying the input to computer system 300 or components thereof. As such, input devices 350 can be used by users or operators of system 105 to input commands, instructions, data, settings, and the like.

Output devices 360, in some examples, may be configured to provide output to a user through visual or auditory channels. Output devices 360 may include a video graphics adapter card, a liquid crystal display (LCD) monitor, a light emitting diode (LED) monitor, an organic LED monitor, a sound card, a speaker, a lighting device, a LED, a projector, or any other device capable of generating output that may be intelligible to a user. Output devices 860 may also include a touchscreen, presence-sensitive display, or other input/output capable displays known in the art.

Computer system 300, in some example embodiments, also includes network interface 370. Network interface 370 can be utilized to communicate with external devices via one or more networks such as one or more wired, wireless, or optical networks including, for example, the Internet, intranet, local area network, wide area network, cellular phone networks (e.g. Global System for Mobile communications network, packet switching communications network, circuit switching communications network), Bluetooth radio, and an IEEE 802.11-based radio frequency network, among others. Network interface 370 may be a network interface card, such as an Ethernet card, an optical transceiver, a radio frequency transceiver, or any other type of device that can send and receive information.

Operating system of computer system 300 may control one or more functionalities of computer system 300 or components thereof. For example, the operating system of computer system 300 may interact with software applications of computer system 300 and may facilitate one or more interactions between the software applications and one or more of processors 310, memory 320, storage devices 330, input devices 350, and output devices 360. The operating system of computer system 300 may interact with the software applications and components thereof. In some embodiments, the software applications may be included in the operating system of computer system 300. In these and other examples, virtual modules, firmware, or software of the software applications. In other examples, virtual modules, firmware, or software may be implemented externally to computer system 300, such as at a network location. In some such instances, computer system 300 may use network interface 370 to access and implement functionalities provided by virtual modules, firmware, or software for vehicle identification through methods commonly known as “cloud computing.”

Thus, the aspects of facilitating business travel management and planning, and the methods and systems for business travel and expense managing have been described. Although embodiments have been described with reference to specific example embodiments, it will be evident that various modifications and changes can be made to these example embodiments without departing from the broader spirit and scope of the present document. Accordingly, the specification and drawings are to be regarded in an illustrative rather than a restrictive sense.

What is claimed is:

1. A method for business travel and expense management, the method comprising:
receiving a travel-related query from a user, wherein the user is related to a business entity;
parsing the travel-related query to derive at least one attribute related to the travel-related query;
determining a normalized allowable budget for the user, the normalized allowable budget being based at least in part on the at least one attribute related to the travel-related query;
selecting one or more feasible travel itineraries for the user based on the normalized allowable budget and the travel-related query; and
presenting the one or more feasible travel itineraries to the user.

2. The method of claim 1, further comprising:
receiving a selection from the user for one of the feasible travel itineraries;
performing automatic booking arrangements associated with the selected feasible travel itinerary;
reporting the booking arrangements to the user and the business entity associated with the user; and
generating an expense report based on the booking arrangements and presenting the expense report to the business entity.

3. The method of claim 1, wherein the at least one attribute includes one or more of the following: travel time and date, a departure location, an arrival location, a travel preference, a hotel selection, a location for hotel accommodation, and a hotel accommodation date.

4. The method of claim 1, wherein a cost of each of the feasible travel itineraries is equal or less than the normalized allowable budget.

5. The method of claim 1, wherein the determining of the normalized allowable budget comprises applying predetermined rules of the business entity against historic travel data.

6. The method of claim 1, wherein the determining of the normalized allowable budget comprises applying a machine-learning algorithm against historic travel data.

7. The method of claim 6, wherein the historic travel data is associated with past travel data of the user.

8. The method of claim 6, wherein the historic travel data is associated with past travel data of other users of the same classification within the business entity.

9. The method of claim 6, wherein the historic travel data is associated with past travel data of other users of the business entity.

10. The method of claim 6, wherein the historic travel data is associated with past travel data of the user, other users of the business entity, and other users of other business entities.

11. The method of claim 1, wherein each of the feasible travel itineraries and the travel-related query includes a plurality of common components, the common components including at least one of the following: a flight, a hotel, a rental car, and an entertainment, wherein the normalized allowable budget is determined for each of the common components.

12. The method of claim 1, further comprising dynamically adjusting the normalized allowable budget based on one or more of the following: a time of day of travel, a day of travel, a special event, or a geographic location of the user.

13. The method of claim 1, further comprising dynamically adjusting the normalized allowable budget based on one or more of the following: a user profile, a business entity profile, and business entity travel guidelines.

14. The method of claim 1, wherein the selecting of each of the feasible travel itineraries for the user is further based on a user classification within the business entity.

15. The method of claim 1, wherein the selecting of each of the feasible travel itineraries for the user is further based on a user profile and a business profile, the user profile including user travel preferences, and the business profile including business travel guidelines.

16. The method of claim 15, wherein the business travel guidelines include variable parameters that cause dynamic adjustment of the normalized allowable budget by a time of day, a day of week, a calendar day, a special event, a geographic location of the user, and a service provider name.

17. The method of claim 1, further comprising enabling the user to remotely create and manage a user profile via a user interface and enabling the business entity to remotely create and manage a business profile via a business interface, wherein the user profile includes user travel preferences, and the business profile includes business travel guidelines for the user.

18. The method of claim 1, further comprising filtering the one or more feasible travel itineraries according to the normalized allowable budget.

19. A travel management system, comprising:
a user interface configured to receive a travel-related query from a user, wherein the user is related to a business entity;
a processing module configured to:
parse the travel-related query to derive at least one attribute related to the travel-related query;
determine a normalized allowable budget for the user, the normalized allowable budget being based at least in part on the at least one attribute related to the travel-related query; and
select one or more feasible travel itineraries for the user based on the normalized allowable budget and the travel-related query, wherein the user interface is further configured to present the one or more feasible travel itineraries to the user.

20. A non-transitory processor-readable medium having instructions stored thereon, which when executed by one or more processors, cause the one or more processors to implement a method for business travel and expense managing, the method comprising:
receiving a travel-related query from a user, wherein the user is related to a business entity;
parsing the travel-related query to derive at least one attribute related to the travel-related query;
determining a normalized allowable budget for the user, the normalized allowable budget being based at least in part on the at least one attribute related to the travel-related query;
selecting one or more feasible travel itineraries for the user based on the normalized allowable budget and the travel-related query; and
presenting the one or more feasible travel itineraries to the user.
